(19) United States
(12) Patent Application Publication
(10) Pub. No.: US 2020/0020068 A1
(43) Pub. Date: Jan. 16, 2020

(54) METHOD FOR VIEWING GRAPHIC ELEMENTS FROM AN ENCODED COMPOSITE VIDEO STREAM

(71) Applicant: UBICAST, Ivry-Sur-Seine (FR)

(72) Inventors: Florent THIERY, Paris (FR); Anthony VIOLO, Bois-Le-Roi (FR)

(73) Assignee: UBICAST, Ivry-Sur-Seine (FR)

(21) Appl. No.: 16/263,574

(22) Filed: Jan. 31, 2019

(30) Foreign Application Priority Data
Jul. 12, 2018 (FR) 1856410

(51) Int. Cl. G06T 1/20; G06T 7/40; H04N 19/182; H04N 19/12

(52) U.S. Cl. CPC G06T 1/20; H04N 19/12; H04N 19/182; G06T 7/40

(57) ABSTRACT

A method for viewing graphic elements from an encoded composite video stream, each of the composite images being formed by a juxtaposition of elementary images including: a step of decoding, initiated by a web browser, for recording into a memory of a graphics card as a texture object corresponding to the original composite images, a step of constructing a final rendered image through a processing by the graphics card consisting in constructing an array of pixels according to a set of drawing parameters, pixels of the elementary images, coordinates of each of the elementary images, and a step of viewing the final succession of rendered images in a user interface of the interactive video player type.

### CROSS-REFERENCE TO RELATED APPLICATIONS

This application claims priority to French Patent Application No. 1856410, filed on Jul. 12, 2018, which is incorporated by reference herein.

### TECHNICAL FIELD

The invention concerns the field of methods and devices for viewing graphic elements from an encoded composite video stream. The invention relates to a method for viewing graphic elements from an encoded composite video stream.

### BACKGROUND

Methods and devices for viewing graphic elements from an encoded composite video stream are known. Such a method is known from the publication US2010/0235857, comprising a step of demultiplexing a multiplexed composite video stream so as to generate a first encoded composite video stream, a step of duplicating the first encoded composite video stream so as to generate a second encoded composite video stream, and decoding each of the two encoded composite video streams. The first decoded composite stream is intended to present a control interface to a user.

The purpose of the second decoded stream is to present the user with a video stream selected from the composite video streams. The selected video stream is selected by the user from the control interface. The disadvantage of this method is that it requires a step of duplication of the first encoded composite video stream and two separate steps of decoding the encoded video stream to decode each of the encoded composite video streams. This U.S. patent publication is incorporated by reference herein.

Another method for viewing graphic elements is known from the publication WO2013150250. This WO patent publication is incorporated by reference herein. According to this publication, it is proposed to display at a given time, in a single video player, for example of the Flash type, an image containing at least two parts of images.

A first part of the image contains a relative image from one of the video streams. A second part of the image, called the additional image part in the publication, can be generated from another video stream. For example, the additional image part may be a thumbnail resulting from the processing of a captured image, with said captured image coming from another part of the current image, relative to the other one of the video streams.

This method makes it possible to display an image of a video stream in one main area of the video player as well as several thumbnails, with each one being generated from the exposed processing, in a particular area of the video player. It should be understood that this method has the disadvantage of being time-consuming in terms of memory and computation time, because it requires a capture, i.e. an image generation, from each of the video streams required to generate the different thumbnails, as well as a scaling of the generated image. In order to reduce the computation time required for the scaling step of the method, the publication provides to repeat the generation of miniatures at a relatively low frequency. This operation is not totally satisfactory, because it generates an increase in memory proportional to the number of video streams the representation of which is used in a thumbnail.

### SUMMARY

One of the purposes of the invention is in particular to remedy all or some of the above-mentioned disadvantages. One idea behind the invention is to request the generation of any part of an image, whether a thumbnail or more generally an image from an encoded composite video stream, from a graphics processing unit (GPU), which results in accelerating calculations. Also, according to a first aspect of the invention, a method is proposed for viewing graphic elements from an encoded composite video stream consisting of a succession of composite images.

Each of the composite images ICt is formed by a juxtaposition of elementary images IEt,ᵢ. Juxtaposition, in this description, both refers to two images arranged side by side as well as two images that may be spaced apart. The encoded composite video stream is for example compliant with the H264 standard.

The composite video stream is associated with a data structure, which describes:
at least one coordinate of each of said elementary images, with respect to a constant reference in the composite image,
at least one set of drawing parameters for each of said elementary images with respect to a, preferably constant, reference in a composition area to be displayed on a screen.
   The drawing parameters can include details on the position, size, depth, opacity. The drawing parameters can be objects in JSON data format (JavaScript Object Notation).

The method includes:
a step of decoding, initiated by a web browser, the encoded composite video stream for recording into a memory of a graphics card as a texture object corresponding to said original composite images,
a step of occasional acquisition of customization parameters,
a step of constructing a final rendered image through a processing by said graphics card consisting in constructing an array of pixels according to said set of drawing parameters, pixels of said elementary images, said coordinates of each of said elementary images and said customization parameters,
displaying the succession of final rendered images in a user interface of the interactive video player type.

With the recording into a memory of a graphics processing unit (GPU), which accelerates calculations, as a texture object corresponding to said original composite images, the processing carried out by the method is much faster than those according to the prior art which requested the calculations from a central processing unit (CPU). In addition, using a graphics card makes it possible to repeat the generation of thumbnails at a frequency equal to that of the main image displayed. A graphics processor generally has a highly parallel structure that makes it efficient for a wide range of graphics tasks such as 3D rendering, using Direct3D, OpenGL, video memory management, video signal processing, Mpeg decompression, etc.

Advantageously, the method may not include the additional step of image capturing as defined in the patent application WO2013150250. The processing time and the memory space used thus increases less rapidly with the number of elementary images. Texture object, in this description refers in particular to an object, in the sense of the application programming interface WebGL which contains an image. The final rendered image is, in the sense of the application programming interface WebGL, a Framebuffer object. The customization parameters can be changed by selecting a part of the user interface with a computer mouse, by using a script, or by using a pointer onto the elementary image.

According to another aspect of the invention, a device is provided for viewing graphic elements from an encoded composite video stream composed of a succession of composite images, each of said composite images being formed by a juxtaposition of elementary images, said composite video stream being associated with a data structure describing:
at least one coordinate of each of said elementary images with respect to a constant reference in the composite image,
at least one set of drawing parameters of each of said elementary images with respect to a constant reference in a composition area to be displayed on a screen,

According to the invention, the device includes:
means so configured as to decode said composite video stream and record same, into a memory of a graphics card, as a texture object corresponding to said original composite images,
means for occasionally acquiring customization parameters,
means for constructing a final rendered image through a processing, by said graphics card, consisting in constructing an array of pixels according to said set of drawing parameters, pixels of said elementary images, said coordinates of each of said elementary images and said customization parameters,
means for viewing the succession of final rendering images in a user interface such as an interactive video player.
   According to yet another aspect of the invention, a computer program product is proposed, downloadable from a communication network and/or stored on a computer-readable and/or a microprocessor-executable medium, and loadable into an internal memory of a computing unit, comprising program code instructions which, when executed by the computing unit, implement the method steps according to the first aspect of the invention, or one or more of its improvements.

### BRIEF DESCRIPTION OF THE DRAWING

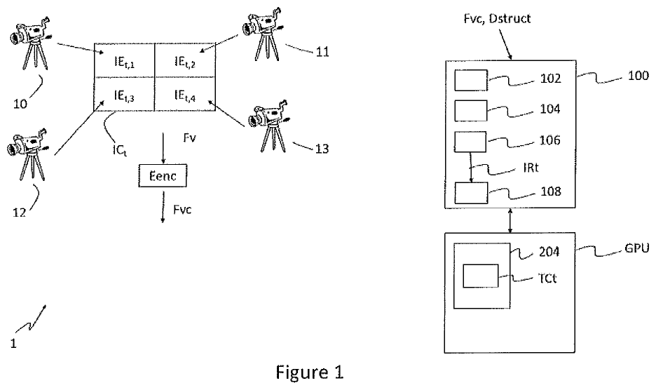

Other advantages and particularities of the invention will appear after reading the detailed description of implementations and embodiments, with regard to appended drawings on which FIG. 1 schematically represents one embodiment implementing a method according to the invention.

### DETAILED DESCRIPTION OF THE EMBODIMENTS

Since the embodiments described below are in no way restrictive, consideration may be given in particular to alternative solutions of the invention comprising only a selection of described characteristics, subsequently isolated from the other characteristics described, if this selection of characteristics is sufficient to confer a technical advantage or to differentiate the invention from the prior art. This selection shall include at least one preferably functional characteristic, without structural details, or with only part of the structural details if that part alone is sufficient to confer a technical advantage or to differentiate the invention from the prior art.

One embodiment of a system 1 implementing a method according to one embodiment of the invention is illustrated in FIG. 1. The system 1 has 4 separate video channels referenced 10, 11, 12 and 13 respectively. At a given time t, each of the channels produces an elementary image, respectively referenced IEt, ₁, IEt, ₂, IEt, ₃, IEt, ₂.

At a given time t, a composite image ICt is formed by a juxtaposition of elementary images. A sequence of composite images forms a composite video stream Fv. This composite video stream is encoded during a step of encoding Eenc to generate an encoded composite video stream Fvc. The composite video stream Fvc can be received by a device 100 in accordance with one embodiment of a device according to the invention, for viewing graphic elements from a composite video stream.

The composite video stream Fvc is associated with a data structure Dstruct, which describes:
at least one coordinate of each of said elementary images IEt, ₁, IEt, ₂, IEt, ₃, IEt, ₄ with respect to a constant reference in the composite image,
at least one set of drawing parameters of each of said elementary images IEt, ₁, IEt, ₂, IEt, ₃, IEt, ₄ with respect to a constant reference in a composition zone to be displayed on a screen.
   The drawing parameters include details on the position, size, depth, opacity.
   The drawing parameters are objects in JSON data format (JavaScript Object Notation).

The device 100 has:
means 102 so configured as to decode the composite video stream Fvc and record same, in a memory 204 of a graphics card GPU, as a texture object TCt corresponding to said original composite images ICt,
means 104 for occasionally acquiring customization parameters,
means 106 for constructing a final rendered image IRt so configured as to implement a processing by a graphics card GPU consisting in constructing an array of pixels according to said set of drawing parameters, pixels of said elementary images IEt, ₁, IEt, ₂, IEt, ₃, IEt, ₄ the coordinates of each of said elementary images IEt, ₁, IEt, ₂, IEt, ₃, IEt, ₄ and the customization parameters,
means 108 for viewing the succession of final rendering images (IRt) in a user interface such as an interactive video player.

The means 102 can be a microprocessor. The texture object is a texture object in the sense of the application programming interface WebGL. The means 104 can be a microprocessor so configured as to occasionally acquire customization parameters, such as selections of image parts to be displayed. The means 106 can be a microprocessor so configured as to give instructions to the graphics card GPU. Of course, the three means 102, 104 and 106 can be a single processor. The display means 108 can be a video player displayed by a web browser.

The processing performed by the graphics card GPU further to one instruction from the means 106 can be, in the case of the implementation of the application programming interface WebGL, the one performed by the instruction gIDrawElements. This instruction uses buffers which do not contain pixels, but vertices or colors. It is thus possible to display a succession of images, with each of the images having a main part and a banner part, with the main part including an image relating to one of the streams of the composite video stream, with the banner part having images from each of the other streams of the composite video stream, with the refresh rate of the image of the main part and each of the images of the banner part being the same, for example 30 images per second.

The composite video stream to be displayed in the image of the main part can be selected by, for example, clicking on another image of the banner part. The image of the main part can include several streams of the composite video stream. When the image of the main part contains several streams of the composite video stream, an image of at least one stream displayed in the main image may be partially obscured by an image of another stream displayed in the main image.

Of course, the invention is not limited to the examples just described and many arrangements can be made to these examples without going beyond the scope of the invention. In addition, the different characteristics, forms, alternative solutions and embodiments of the invention may be combined with each other in various combinations provided that they are not incompatible or exclusive of each other.

1. A graphics display system comprising:
(a) a composite encoded video stream containing a plurality of channels, including at least a first channel and a second channel;
(b) a graphics processing unit and a memory coupled to the graphics processing unit, wherein the memory stores instructions that, upon execution, cause the graphics processing unit to:
(i) obtain the first channel and the second channel for a plurality of given times;
(ii) create, for the plurality of given times, a sequence of composite images based on, for a first composite image of the sequence of composite images, an arrangement of the first channel and an arrangement of the second channel; and
(iii) display the sequence of composite images, wherein the sequence of composite images includes a first portion where the first channel is displayed and a second portion where the second channel is displayed, and wherein the first portion and the second portion are adjustable.

2. The graphics display system of claim 1, wherein the graphics processing unit and the memory is included on a graphics card, the graphics processing unit further configured to:
store images from the first channel and the second channel onto the memory;
obtain customization parameters; and
create the sequence of composite images according to the customization parameters.

3. The graphics display system of claim 2, wherein the sequence of composite images is created using the images from the first channel and the second channel stored onto the memory of the graphics card.

4. The graphics display system of claim 2, wherein the sequence of composite images is created according to a first set of drawing parameters corresponding to the first channel and a second set of drawing parameters corresponding to the second channel.

5. The graphics display system of claim 2, wherein storing the images from the first channel and the second channel includes storing the images from the first channel and the second channel as a texture object, and wherein the texture object is associated with to the composite video stream.

6. The graphics display system of claim 1, wherein the sequence of composite images is displayed to an output device configured to receive input to adjust the sequence of composite images.

7. The graphics display system of claim 6, wherein the instructions, upon execution, cause the graphics processing unit to create a second sequence composite video stream of a second sequence of composite images, wherein the second sequence composite video stream is a set of thumbnails corresponding to the first channel or the second channel.

8. (canceled)

9. The graphics display system of claim 6, wherein a user interface of the output device includes user-adjustable customization parameters, wherein, in response to the user-adjustable customization parameters being adjusted, the first portion and the second portion of the sequence of composite images is accordingly adjusted.

10. The graphics display system of claim 1, wherein the sequence of composite images is associated with a data structure, and wherein the data structure defines a correspondence between at least one coordinate of a first elementary image of the first channel and a corresponding composite image including the first elementary image in the first portion.

11. The graphics display system of claim 10, wherein the data structure defines a set of drawing parameters for the first elementary image, and wherein the corresponding composite image including the first elementary image is created according to the set of drawing parameters.

12. The graphics display system of claim 10, wherein each elementary image has a corresponding set of drawing parameters.

13. The graphics display system of claim 1, wherein the sequence of composite images is ordered based on a corresponding given time of each composite image.

14. The graphics display system of claim 1, wherein each composite image of the sequence of composite images is arranged according to a corresponding arrangement of elementary images included in a corresponding composite image.

15. The graphics display system of claim 1, wherein the arrangement of the first channel and the arrangement of the second channel includes at least one of:
(a) the first channel and the second channel arranged side by side; and
(b) the first channel and the second channel being spaced apart.

16-17. (canceled)

18. A graphics display method comprising:
(a) obtaining an encoded composite video stream composed of a plurality of composite images, wherein each of the plurality of composite images has an associated order, and wherein the plurality of composite images is generated from a plurality of elementary images;
(b) decoding the encoded composite video stream into a plurality of original composite images;
(c) identifying a texture object associated with the plurality of original composite images;
(d) storing the texture object into a memory of a graphics card including a graphics processing unit;
(e) obtaining customization parameters;
(f) constructing an array of the associated plurality of extracted elementary images based on the customization parameters and the associated order, wherein in at least one coordinate of each of the associated plurality of extracted elementary images refers to a reference point of a corresponding one of the plurality of original composite images;
(g) creating a sequence of composite images according to the constructed array; and
(h) displaying the sequence of composite images.

19. The graphics display method of claim 18, wherein the plurality of elementary images include at least two elementary images, each of the two elementary images including an associated juxtaposition based on the other elementary image.

20. The graphics display method of claim 19, wherein the associated juxtaposition includes at least one of:
(a) a first image of the plurality of elementary images and a second image of the plurality of elementary images being arranged side by side; and
(b) the first image of the plurality of elementary images and the second image of the plurality of elementary images being spaced apart.

21. (canceled)

22. The graphics display method of claim 18, wherein each image of the plurality of elementary images has an associated given time at which the image was captured.

23. The graphics display method of claim 22, further comprising obtaining a first elementary image of the plurality of elementary images and a second elementary image of the plurality of elementary images by accessing the first elementary image from a first channel of the plurality of channels and the second elementary image from a second channel of the plurality of channels from the memory.

24. The graphics display method of claim 18, further comprising adjusting the displaying of the sequence of composite images in response to user-adjustable customization parameters being adjusted.

25. The graphics display method of claim 18, wherein each of the plurality of elementary images corresponds to a set of drawing parameters, and wherein the set of drawing parameters include at least one of:
(a) a position;
(b) a size;
(c) a depth; and
(d) an opacity.

26. A graphics display system comprising a graphics processing unit and a memory coupled to the graphics processing unit, wherein the memory stores:
(a) texture objects of images of a composite video stream; and
(b) instructions that, upon execution, cause the graphics processing unit to:
identify a texture object associated with a plurality of original composite images;
store the texture object in the memory;
obtain display parameters;
extract a plurality of elementary images from the plurality of original images;
create a final rendered image for each of the plurality of original composite images based on the obtained display parameters an associated juxtaposition of each of the plurality of elementary images included in the plurality of original composite images; and
display the created final rendered images.

27. The graphics display system of claim 26, wherein each of the plurality of original composite images corresponds to at least one coordinate of at least one of the plurality of elementary images that composed an encoded composite video stream.

28. The graphics display system of claim 26, wherein the created final rendered images are displayed via a web browser.

29. The graphics display system of claim 26, further comprising a user interface configured to display the created final rendered images.

30. A non-transitory computer-readable medium storing processor-executable instructions, the instructions comprising:
(a) obtaining an encoded composite video stream composed of a plurality of composite images, wherein each of the plurality of composite images have an associated order, and wherein the plurality of composite images is generated from a plurality of elementary images;
(b) decoding the encoded composite video stream into a sequence of original composite images;
(c) identifying a texture object associated with the sequence of original composite images;
(d) storing the texture object into a memory of a graphics card;
(e) obtaining customization parameters;
(f) constructing an array of pixels of the plurality of elementary images based on the customization parameters;
(g) generating a final rendered image for each of the plurality of composite images according to the constructed array of pixels; and
(h) displaying each of the final rendered image according to the associated order of each of the plurality of composite images.

31. The graphics display system of claim 1, wherein the first portion and the second portion are overlapping.

32. The graphics display method of claim 18, wherein the sequence of composite images includes images of a first channel and a second channel, and wherein the first channel is displayed in a first area and the second channel is displayed in a second area to create the sequence of composite images.

33. The graphics display method of claim 23, wherein a first image of the first elementary image of the plurality of elementary images is stored on the memory of the graphics card until a subsequent elementary image of the plurality of elementary images replaced the stored first elementary image.

34. The graphics display system of claim 26, wherein the created final rendered image is a combination of images of a first channel and a second channel, wherein images of the first channel are displayed in a first portion and images of the second channel are displayed in a second portion.
